(19) United States
(12) Patent Application Publication
(10) Pub. No.: US 2008/0273073 A1
(43) Pub. Date: Nov. 6, 2008

(54) System and method for application of ink formulations onto ophthalmic lenses

(75) Inventor: Glyn Oakley, Brooklyn, CT (US)

Correspondence Address: KEUSEY, TUTUNJIAN & BITETTO, P.C., 20 CROSSWAYS PARK NORTH, SUITE 210, WOODBURY, NY, 11797, US

(73) Assignee: GENTEX OPTICS, INC.

(21) Appl. No.: 11/799,441

(22) Filed: May 1, 2007

(51) Int. Cl. B41J 2/21; B41J 2/01

(52) U.S. Cl. 347/103

(57) ABSTRACT

A system and method for applying an ink composition to an ophthalmic lens is described providing at least one ophthalmic lens having a meniscus-shaped surface, and providing an ink composition formulated for either removable or non-removable as well as non-bleeding ink jet application onto the surface of the lens. The ink composition is jetted directly onto a stamp via an ink jet print head to form a printed image on the stamp, and the printed image is permitted to set for at least an ink drying period. The printed image is oriented with respect to the lens to align the printed image with a desired location and the printed image is applied onto the lens surface with the stamp to form a mark. Preferably, the duration of the ink drying period is sufficient to at least prevent bleeding of the ink into the lens upon application onto the lens surface.

### BACKGROUND

1 Technical Field

The present invention relates generally to application of an ink composition onto a curved substrate, and in particular, to a system and method for printing onto a surface of an ophthalmic lens.

2. Description of Related Art

Printing images on curved, non-planar surfaces is typically performed via pad printing systems, which utilize a deformable pad for receiving images from a flat cliche plate and transfers same to the curved surface to be printed. A cliche typically comprises a metal plate with engraving marks therein and is used for some ink application processes.

With conventional pad printing systems, however, it is difficult to achieve high quality multicolor images on curved items. It is inherently difficult to print the individual single color images which comprise a multicolor image in precise overlapping relation. For example, some of the steps that have to be performed for multicolor pad printing include color separation, producing the film for each color, dip coating the plates and setting up the various inks. Additionally, cycling the printing pad through the various color stations is a time consuming process which reduces output and increases costs.

Further, it often takes several weeks to set up a conventional multicolor pad printing system to run a particular image, and hence many multicolor pad printing systems are not readily or cost-effectively adaptable to print custom images.

Moreover, in the prior art, the cliche (printing station) is stationary and it is the lens that must be oriented to receive a stamp in the correct location. For example, an apparatus holding a plurality of lenses includes a carousel and fixtures configured to position/rotate each lens to a desired position and bring each lens to the printing station.

U.S. Pat. No. 6,276,266 to Dietz et al. discloses a multicolor pad printing system in which images are printed onto a flat releasing substrate and a deformable transfer pad is contacted with the releasing substrate to receive a multicolor image therefrom. The transfer pad is movable into pressure contact onto an object to print the image thereon.

U.S. Pat. 6,840,167 to Clark shows a fixed frame 305 that holds pad 300. The inkjet image 215 is printed onto pad 300. A ram 410, or hydraulic pressure as shown, e.g., in FIG. 9, is used to deform pad 300 into a convex shape. The image is then stamped onto a variety of flat, curved or irregular surfaces including watch faces, golf balls and bottles.

U.S. Pat. No. 6,776,100 to Cutcher also avoids using a cliche by having an image screen printed onto a flat membrane. Cutcher discloses an apparatus and method for transferring an image to a substrate having a surface which may be planar or non-planar. An image is printed on a membrane and a forming fixture shapes the printed membrane into a complementary shape to the substrate. The membrane/forming fixture is contacted with a substrate to effect the transfer of the image on the membrane onto the substrate. However, where layers of images are desired and/or different pigments are desired, different portions of the membrane or multiple membranes are required to be used.

U.S. Pat. No. 6,520,999 and U.S. Pat. No. 6,736,863 to Nidek disclose applying a dye to a plastic lens by first inkjet printing an image onto a flat sheet. The '999 reference involves non-contact tinting of a fine gradient pattern onto a lens, and the '863 reference describes contact printing of a logo. As can be seen in FIG. 2 of '863, the lens 3 is placed in a fixture 32, and the image sheet 10 is pressed against the (concave) lens surface by a silicone pad 31. The image is transferred to the lens under the influence of heat and vacuum to sublimate the dye onto the lens.

Japanese Abstract JP-2003-145747 discloses jetting erasable ink directly onto the surface of an eye glass lens by supporting the lens within a short distance range from the inkjet print head. Namely, JP 2003-145747 teaches an apparatus and method for marking a pattern on an eyeglass lens wherein liquid ink from an inkjet head is ejected directly onto the surface of the eyeglass lens. However this marking technique is limited to marking of a predefined convex surface, in which the marking pattern of the inkjet head must be predetermined based on the dimensions of the lens surface to be marked.

U.S. Patent Application No. 2005-0001979 discloses inkjet printing directly onto a pad in FIGS. 2 and 3. The image is then stamped onto the contact lens substrate 22 in FIGS. 4 and 5. FIGS. 6, 7 and 8 disclose a pan and tilt mechanism 134 which adjusts the position of a contact lens relative to inkjet print head 130, for direct ink jetting thereon.

EP1171305 teaches an apparatus for printing three-dimensional objects, namely spherical objects, comprising a pad having a silicon (half-spherical) shape which is supplied with compressed air. The pad is pressed against an initially inked surface, whereupon the half-spherical surface of the pad is flattened so that the figures from the inked surface are transferred to the pad surface. Subsequently, the pad is pressed against a three dimensional spherical/curved surface for printing the inked image onto the desired spherical/curved part of the object. However, image designs/colors are limited with this technique, due to the necessity of direct contact of the pad surface with an initially inked surface.

U.S. Pat. No. 6,365,074 teaches a method of using an ink jet printer or similar printing device to print an identification mark onto a facing inside surface of a mold used to form a lens and subsequently transferring the identification mark from the mold directly to the lens when the lens is formed. However, the lens marking process is limited to the placement of marks during in-mold formation of lenses.

U.S. Patent Application No. 2006/0043623 involves a system and method for making tinted ophthalmic lenses in which ophthalmic lens mold halves are provided, at least one of which includes a colorant which may be provided using a suitable printing method. The colorant is applied to uncured lens material by transfer of the colorant from the mold surface to the lens material, and the lens material is subsequently cured. The portion of the lens-forming material in contact with the colorant remains substantially uncured to permit diffusion of the colorant into the lens.

EP 0898601 discloses a composition suited for use with silicone rubber transfer-pads to print alphanumeric patterns on curved or spherical surfaces such as ophthalmic lenses. This reference teaches a type of ink composition which is specially adapted for a transfer-pad printing method of printing a pattern of a liquid coating from a printing block (cliche) to a substrate surface, so as to avoid problems such as beading, and provide abrasion and moisture resistance. This technique, however, is limited in the colors/designs which may be provided in an imprint.

Current processes for ink application onto a lens incorporate the application of ink to a cliche from an inverted ink container. After the ink is incorporated into engravings of the cliche there is a brief period of drying time which allows the ink to skin over while a rubber tamper is moved to and impressed onto the cliche. This process allows the ink to be transferred to the rubber tamper in the form and shape of the engravings on the cliche. Again there is a brief period of drying or ‘skinning’ time that allows the ink to skin over while the tamper is moved to the lens and/or the lens is moved to the tamper. This skinning time in combination with specific ink formulations facilitates transfer of the ink to the lens in a “temporary” or removable manner so as to prevent undesirable ghosting when the ink is removed during later lens processes. Many different types of inking equipment are based on these ink transfer principals.

However, the above-mentioned process incorporating the use of a cliche is deficient when more complex shapes, designs and/or customer logos are required to be placed on the lens. In addition, applying multiple colors using a cliche is problematic, since the use of more than one stamp tends to cause ink from the first application to be smudged and/or removed during subsequent applications.

Accordingly, a system and method for application of an ink composition, e.g., including multicolor images onto curved surfaces, namely ophthalmic lenses, is highly desirable.

### SUMMARY OF THE INVENTION

The present invention overcomes the limitations and problems relating to ink application processes used to highlight engraving marks specifically on progressive semi-finished ophthalmic lens blanks and other substrates requiring ink applications based on the use of a cliche. Namely, according to one aspect, a system and method is provided for utilizing an ink jet type process for application of an ink formulation directly onto a tamper or stamp without the use of a cliche. After the ink is applied to the tamper, a period of time is allotted to allow the ink to sufficiently cure or ‘skin’ over. Then, the image is stamped onto a convex/concave lens surface.

According to one embodiment, the ink drying period in combination with specific ink formulations advantageously facilitates temporary, non-bleeding and removable application of the ink composition onto an ophthalmic lens surface. According to another embodiment, an ink application method according to the present invention enables creation of removable or permanent (non-removable) customized markings on ophthalmic lens surfaces with improved efficiency.

Advantageously, a system and method according to the present principles provides at least the following distinct advantages over existing ink application processes:

1. Multiple colors may be efficiently created/applied onto the same surface, namely, the same ophthalmic lens.

2. A single ink printer may be used in lieu of multiple cliche stations.

3. Individualized and customized logos, designs and images may be efficiently and cost-effectively created and applied onto a curved surface, namely an ophthalmic lens.

4. The application process eliminates many of the ink spillage issues associated with cliche applications and thus is cleaner and minimizes waste.

5. Either the lens or the imprinted image on a pad may be oriented with respect to each other.

According to one aspect, a method for applying an ink composition to an ophthalmic lens is provided comprising the steps of providing at least one ophthalmic lens having a meniscus-shaped surface, providing an ink composition formulated for removable and non-bleeding application onto the surface of the lens, the ink composition having at least a viscosity compatible with ink jet printing, jetting the ink composition directly onto a stamp via an ink jet print head to form a printed image on said stamp, and pausing for at least an ink drying period and orienting the printed image with respect to the lens to align the printed image with at least one lens feature. The printed image is applied onto the lens surface with the stamp to form a registration mark, wherein the ink drying period is of a time duration sufficient to at least prevent bleeding of the ink into the lens upon application onto the lens surface.

According to another aspect, a method for applying an ink composition to an ophthalmic lens is provided comprising the steps of providing at least one ophthalmic lens having a meniscus-shaped surface, providing an ink composition formulated for non-removable and non-bleeding application onto the surface of the lens, the ink composition having least a viscosity compatible with ink jet printing, jetting the ink composition directly onto a stamp via an ink jet print head to form a printed image on said stamp, and pausing for at least an ink drying period. The printed image is oriented with respect to the lens to align the printed image with a specified location on the lens. The printed image is applied onto the lens surface with the stamp to form a permanent mark, wherein the ink drying period is of a time duration sufficient to at least prevent bleeding of the ink into the lens upon application onto the lens surface.

These and other aspects, features and advantages of the present invention will be described or become apparent from the following detailed description of the preferred embodiments, which is to be read in connection with the accompanying drawings.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings, wherein like reference numerals denote similar components throughout the views:

FIG. 1A is a schematic drawing of a stamp in relation to an ink jet print head.

FIG. 1B is a schematic drawing of exemplary embodiments of image orienting systems.

FIG. 1C is a progressive lens having registration marks printed thereon.

FIG. 2 is a schematic drawing of a stamp and screen in relation to an ink jet print head.

FIG. 3 is a flowchart outlining process steps according to one embodiment.

FIG. 4 is a flowchart outlining process steps according to another embodiment.

### DETAILED DESCRIPTION OF PREFERRED EMBODIMENTS

The present invention provides an improved system and method for applying ink images, which may comprise, e.g., multi-color images, to curved surfaces, namely convex or concave surfaces of hard ophthalmic lenses. A system according to the present invention is advantageously readily adaptable to print custom images onto coated and uncoated optical lenses. Further, a system according to the present invention advantageously permits not only the orientation and positioning of a lens with respect to an image to be stamped thereon, but also enables the orientation/positioning of an imprinted image with respect to, e.g., a stationary lens.

According to an aspect of the present invention, a temporary or permanent marking or logo may be uniformly and precisely applied to, e.g., a hard ophthalmic lens with improved efficiency and flexibility, minimal transfer time and reduced printing ink waste. Namely, the objectives of the present invention are achieved through a novel lens printing and stamping methodology described herein with reference to the Figures.

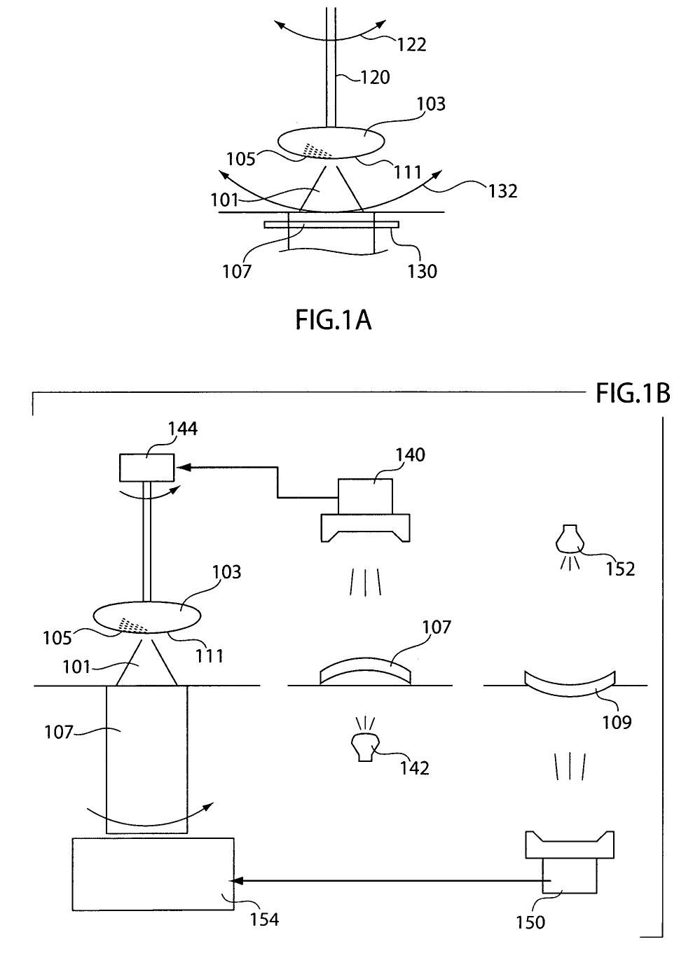

Referring now to the Figures, FIGS. 1A and 1B are exemplary illustrations of an apparatus setup suitable for practice of the present invention, according to one exemplary embodiment. An ink composition 105 is provided formulated for being dispensed via an ink jet printer 107 having at least one ink jet printer head 101 configured for imprinting logos, patterns, markings, etc. directly onto a surface 111 of a tampon 103. Tampon 103 may be used to apply the ink composition 105 in the form of various images onto ophthalmic lenses, namely a convex surface 107 or a concave surface 109 of an ophthalmic lens. The tampon or stamp 103 may be comprised of any flexible, deformable, inflatable or resilient material such as, e.g., rubber, silicone, plastic, foam, etc.

In order to maintain a consistent, non-contact distance between print head 101 and stamp 103, a mechanical solution may be employed. For example, as shown in FIG. 1A, a first arm 120 that supports the stamp, may pivot along an arc 122. Alternatively, a second arm 130 that supports print head 101 may pivot along an arc 132. In order to properly orient the registration mark, it is possible to analyze lens 107 using a sensor 140 (FIG. 1B) that may collect data about optically modified light rays emanation from a source 142 and passing through lens 107. The sensed data may be communicated to a stamp controller 144. Controller 144 may be configured to rotate stamp 103 so it is in proper alignment when it contacts lens 107. Advantageously, the lenses can be transferred into the printing station in any orientation. The stamp can be rotated to the proper alignment during the ink drying period.

Alternatively, it is possible to analyze lens 109 using a sensor 150 that may collect data about optically modified light rays emanation from a source 152 and passing through lens 109. The sensed data may be communicated to a print head controller 154. Controller 154 may be configured to rotate print head 107 so the printed image is in proper alignment when stamp 103 contacts lens 109. A cleaning station may be provided within the printing station to clean the stamp before additional ink is jetted onto it. Sensed data may be used to cooperatively orient the stamp and the print head. The key requirement is that the lens and stamp are in proper alignment with respect to each other when the stamp contacts the lens. The arcs 122 and 132 may be adjusted to compensate for lens surfaces having different base curves.

Ophthalmic lenses used in the invention may be uncoated or coated (e.g., for abrasion resistance, tinting, anti-reflectivity, etc.). Plastic lenses are often coated with, for example, films derived from polysiloxane, acrylate, epoxy, or urethane based compounds for abrasion resistance, and with multilayer films comprising silica, titania and/or niobia for anti-reflectivity.

Various ink compositions preferably formulated for ink jet printing may be utilized in a system and method according to the present invention. The ink compositions can be employed to imprint any article which can be imprinted by, e.g., ink pad printing, though is hereby illustrated with printing onto hard ophthalmic lenses. With respect to ophthalmic lenses, the markings may comprise ‘temporary’ (removable) or permanent (non-removable) markings. Removable markings may be used in the production of lens products and are preferably applied so as to be fully removable without causing ‘ghosting,’ i.e., wherein the ink bleeds into the lens surface (e.g., through the tintable coating) such that when removed the ink is still visible in the lens.

For example, temporary registration markings may be applied to identify reference points on a lens, e.g., fitting cross, prism point, near measurement etc., which guide laboratory personnel in grinding, polishing and otherwise fitting the prescription to that required for the final lens product. FIG. 1C shows a progressive lens 160 with registration marks printed thereon. Some marks 162 may be printed in a first color while other marks 164 may be printed in a different color. Previously, two cliches would be needed to accomplish the same two color printing. The system according to the invention can print two or more colors in one pass. As can be appreciated by those skilled in the art, the location of the lens features must be known for machining operations. Also, the location must be known for edging operations. While the registration mark may simply serve as a visual indicator, the ink jet printer may be configured to imprint markings such as bar codes which could convey additional lens information, e.g., lens material, power, coating type, etc.

Ophthalmic lenses processed according to the present invention may be comprised from, e.g., crystalline quartz, fused silica, soda-lime silicate glass, and plastics such as polymers based on allyl diglycol carbonate monomers (available as CR-39™ from PPG Industries, Inc., Hartford, Conn.), diacrylate or dimethacrylate compounds (e.g., as described in U.S. Pat. Nos. 5,373,033 and 4,912,185, both incorporated herein by reference, and which are available as SPECTRALITE™ from Sola Optical USA, Inc. Petaluma, Calif.), and polycarbonates, e.g., such as LEXAN™, available from General Electric Co. Ophthalmic lenses may also include laminated lenses that are fabricated by bonding two lens wafers (i.e., a front wafer and a back wafer) together with a transparent adhesive. Laminated lens wafers are described, for example, in U.S. Pat. Nos. 5,149,181, 4,857,553, and 4,645,317 and U.K. Patent Application GB 2,260,937A, all of which are incorporated herein by reference. Suitable lens substrates further include glass ophthalmic lenses, as described, for instance, in U.S. Pat. Nos. 3,899,315 and 3,899,314, both of which are incorporated herein. As used herein, the term ‘lens’ may refer to single integral body and/or laminated types.

A lens imprinted according to an aspect of the present invention may comprise an uncoated lens, or a lens coated with one or more coatings for abrasion resistance, anti-reflectivity, etc. Ophthalmic lenses, particularly plastic ones, that are coated with a polymeric abrasion or scratch resistance coating, e.g., about 1 μm to about 12 μm thick, are also suitable substrates. The thickness of the polymeric scratch resistance coating will depend, in part, on the substrate material. Generally, plastic materials such as polycarbonates will require thicker coatings. Suitable lenses may also include an anti-reflection (AR) coating, e.g., a substantially transparent multilayer film that is applied to the lens surface(s) thereof to substantially eliminate reflection over a relatively wide portion of the visible spectrum, and thereby increase the transmission of light and reduce surface reflectance. Exemplary anti-reflection coatings include multilayer films comprising alternating high and low refractive index materials (e.g., metal oxides) as described, for instance, in U.S. Pat. Nos. 3,432,225, 3,565,509, 4,022,947, and 5,332,618, all of which are incorporated herein by reference. The thickness of the AR coating will depend on the thickness of each individual layer in the multilayer film and the total number of layers in the multilayer film. The AR coating can include any number of layers. Preferably, the AR coating for the ophthalmic lens has about 3 to about 12 layers, more preferably about 4 to about 7 layers, and most preferably about 4 layers. Preferably, the AR coating is about 100 to about 750 nm thick. For use with ophthalmic lenses, the AR coating is preferably about 220 to about 500 nm thick.

The term “soluble polymer” used herein refers to suitable water soluble polymers that are compatible with the other components of the ink composition to form an aqueous polymer mixture which produces a polymer composition with the other components impregnated therein when the mixture is dried. Soluble polymers include, for example, suitable urethanes, acrylates, epoxies, cellulose, and vinyl derivatives. Specific examples, include, polyurethanes available as NEOREZ™ from Zeneca Resins, Wilmington, Mass., styrene acrylates available as JONCRYL™ from Johnson Wax Co., Racine, Wis., hydroxypropylcellulose available as KLUCEL™, cellulosic polymers available as AMBERGUM™ both from Aqualon Co., Wilmington, Del., and aqueous vinyl polymer mixtures that are available under the designations AW850, AW 100, AW870, AW875 and WBV 100 from Union Carbide, Danbury, Conn. Preferred soluble polymers are thermoplastic.

Preferred soluble polymers for an ink composition according to one aspect of the present invention comprise vinyl resins which are vinyl polymers or copolymers that are soluble in water at room temperature. The presence of an aqueous colloidal dispersion of said vinyl resins in the ink composition is preferable for achieving the desired flowability, printability and durability of the marking ink, namely ink used for imprinting temporary marks, as such ink also has good redispersibility characteristics and is easy to remove. Preferably, the vinyl resin is a vinyl chloride copolymer. Suitable vinyl chloride copolymers are available as a waterborne vinyl dispersant such as, for example, the UCAR™ waterborne vinyls (available from Union Carbide, Danbury, Conn.). A preferred waterborne vinyl resin dispersion is AW-850™ which contains about 40% solids, is available from Union Carbide. An exemplary soluble polymer typically comprises from about 10% to about 30%, preferably about 15% to 25%, and more preferably about 20% to 25% of the ink composition when first formulated, that is, prior to drying. (All percentages herein are on a weight basis). Another preferred waterborne vinyl resin dispersion is WBV 100 which contains about 50% solids. This soluble polymer comprises from about 10% to 30%, preferably about 15% to 25%, and more preferably 20% to 25% of the ink formulation.

The term “dispersant” refers to any suitable substance which acts as a wetting agent to disperse the ink components to form an aqueous mixture wherein the undissolved fine solid particles are uniformly distributed and separated. Preferred dispersants include, for example, water-reducible alkyds, acrylics, polyesters, epoxies, and mixtures thereof. DISPERSE-AYD W-22™ (available from Daniel Products, Jersey City, N.J.) is a preferred dispersant. The dispersant may comprise from about 0.5% to 5.5%, preferably from about 1% to 5%, and more preferably from about 1% to 2.5% of the aqueous ink composition.

The term “release agent” refers to any suitable substance that acts as a lubricant to render the aqueous ink composition more readily transferable from the ink pad to the substrate (e.g., lens) surface. Silicone rubber material is described, for example, in WO92/20005. Suitable release agents include, for example, silicone fluids. A preferred release agent is a silicone fluid available as SF1188™ from General Electric Co., Waterford, N.Y. The release agent may comprise from about 10% to 30%, preferably from about 12.5% to 27.5% and more preferably about 15% to 20% of the aqueous ink composition.

The term “colorant” refers to suitable substances which impart color to another material or mixture. Colorants may be used as desired to render uniqueness to the mark, e.g., “color coding.” Colorants may comprise nonsoluble inorganic or soluble organic dyes. Exemplary colorants include, e.g., Erioglaucine (turquoise blue) and Tartrazine (yellow) both available from Aldrich Chemical Co., Milwaukee, Wis. When present, the colorant may comprise from about 0.25% to 7.5%, preferably from about 0.5% to 5%, and more preferably from about 0.5% to 2.5% of the ink composition.

An ink composition utilized in accordance with the present invention is preferably formulated to be employed for dispensing by ink jet printers for printing a marking/design onto the surface of an article, namely an ophthalmic article (e.g., a lens surface). For example, an ink composition is preferably at least of a viscosity compatible with ink jet printing.

An exemplary aqueous ink composition for use may be comprised of about 20% to 50% water, preferably about 25% to 45%, and more preferably about 35% to 45%. The composition is thixotropic and has a viscosity of about 1,000 cp to 20,000 cp, preferably about 5,000 cp to 15,000 cp, and more preferably about 7,500 cp to about 12,500 cp at room temperature.

The following Examples 1-6 describe exemplary ink compositions formulated for imprinting removable markings:

### EXAMPLE 1

To 54.3 g of AW850 (soluble polymer) add 10.81 g of deionized water under stir. To this add 1.63 g of DISPERS-AYD W22 (dispersant). 0.81 g Erioglaucine and 0.11 g Tartrazine (colorants) are then added and the mixture is stirred for 15 minutes. Next add 14.12 g of titanium dioxide and continue stirring for a further 2 hours. Finally, add 18.19 g of the SF1188™ (release agent) and stir for 2 more hours. This formulation achieves a teal colored ink.

### EXAMPLE 2

The same mixing procedure as Example 1 except replace the AW850 with 54.3 g of WBV 110.

### EXAMPLE 3

To 60.88 g of AW875 add 1.79 g of DISPERS-AYD W22 under stir. 0.9 g Erioglaucine and 0.11 g Tartrazine are then added and the mixture is stirred for 15 minutes. Next add 15.92 g of titanium dioxide and continue stirring for a further 2 hours. Finally, add 20.52 g of the SF1188™ and stir for 2 more hours. The formulation achieves a teal colored ink.

### EXAMPLE 4

To 64.31 g of AW875 add 1.29 g of DISPERS-AYD W22 under stir. 0.96 g of Tartrazine is then added and the mixture is stirred for 15 minutes. Next add 15.43 g of titanium dioxide and continue stirring for a further 2 hours. Finally, add 18.0 g of SF 1188™ and continue stirring for 2 hours. The formulation achieves a yellow colored ink.

### EXAMPLE 5

The same mixing procedure as Example 4 except replace the AW850 with 64.31 g of WBV110.

### EXAMPLE 6

The same mixing procedure as Example 4 except replace the AW850 with 64.31 g of AW875.

After lenses are printed with the exemplary ink compositions of Examples 1-6 above, the markings on the surfaces of the lenses are formed upon drying of the ink composition. At room temperature, drying occurred within a few seconds or less when air is blown on the aqueous ink composition. The markings were easily removable with water.

The ink jet printing apparatus 107 according to an aspect of the present invention may comprise any conventional ink-jet printer, such as a thermal or bubble jet printer, a piezoelectric printer, a continuous flow printer, a valve jet printer, etc. For example, the inkjet printer 107 may comprise a Hewlett Packard™ HP2000C inkjet printer, an Epson Stylist™ color 880 printer, or any other suitable inkjet printer.

The inkjet printer 107 preferably comprises a plurality of inkjet print heads 101 and an advancing mechanism (not shown) for moving the print heads 101 during a printing operation. Preferably, the print heads 101 are adapted to jet/dispense non-bleeding ink compositions comprised of e.g., multiple colors to facilitate full color (multicolor) printing of an image. Each ink jet print head 101 is preferably operably connected to and controlled by a microprocessor (not shown) configured to control the process of, e.g., creating at least one image comprising an ink pattern, and selecting at least one ink pattern from a plurality of ink patterns.

The tampon or stamp 103 is preferably comprised of a resilient, flexible material (e.g., silicone rubber) and is operably connected to a pad orienting mechanism for moving and orienting the pad. The printer 107 is adapted and configured to ultimately print an image (e.g., a digital graphic image) onto a lens substrate 107, 109. Namely, the printing apparatus 107 is preferably configured to print an image onto a surface of the transfer pad 103 via the print heads 101. A system according to an aspect of the present invention is configured to then transfer the imprinted image from the surface of the pad 103 to the surface of the lens substrate (107 and/or 109).

The image may comprise, e.g., a digital graphic image and be generated on any computer or microprocessor device (not shown) using commercially available software, such as Adobe Illustrators, commercially available from Adobe Systems Incorporated of Palo Alto, Calif., or Paint Shop Pro™, commercially available from JASC Software, Inc. of Eden Prairie, Minn. The digital graphic image may be artistically rendered using the software, may be a scanned image, or may be generated by a digital camera. The computer preferably communicates with the printing apparatus 107 via any suitable data transfer device (e.g., conventional data transfer lines (not shown)) capable of transmitting digitally generated images electronically. The image may comprise any desired image to temporarily or permanently mark a lens substrate. The software controlling the printing, may accommodate for the curved surface of pad 103 and/or the varying distance between the pad surface and the ink jet head 107. In other words, the software would compensate so that the image on the lens is clear and undistorted. The stamp may be inflated or deflated to take on different size shapes, i.e. hemispherical shapes having different radii. The software or motion controllers (that pivot along arcs 122 and 132) may adjust to the different size/shape of the stamp. For example, in response to a different base curve or lens feature, a different inflation level and print settings could be cooperatively employed to optimize the clarity of the printed image.

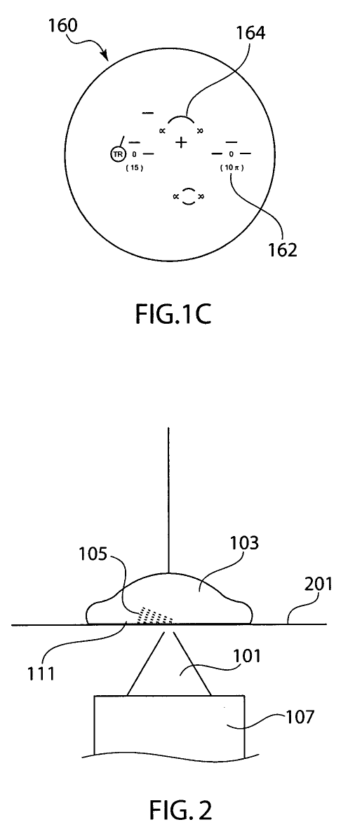

FIG. 2 illustrates an alternate exemplary embodiment for imprinting an ophthalmic lens according to the present invention. In this embodiment, a surface 111 of the pad 103 is brought into contact with a screen 201 and compressed so as to be substantially flat. The screen 201 may comprise any porous or perforated material that may be oriented in a substantially planar configuration. The screen 201 is openly permeable so as to allow free pass-through of a liquid composition (e.g., an ink composition) and may comprise, e.g., a honeycombed or mesh-like material.

An ink jet printer 107 may be positioned so as to project the ink composition 105 via a plurality of printer heads 101 in a desired pattern or design onto the flattened surface 11 of the pad 103 to form a printed mark or image thereon. The pad 103 having an imprinted image may be oriented and moved with respect to a lens (to face a surface of a convex lens 107 or a concave lens 109) via a pad orienting mechanism (not shown) to, e.g., align the printed image with at least one lens feature. Lens features may comprise, for example, progressive lens powers, asymmetrical optical centers (that is the optical center is not in the geometric center of the lens) and polarizing films or filters on the lens.

Advantageously, the pre-flattening of the pad surface 111 prior to imprinting of same with the ink composition facilitates the creation of a more accurately dimensioned, shaped and sized imprinted image by the pad 111 onto a curved surface (e.g., the surface of a convex or concave ophthalmic lens).

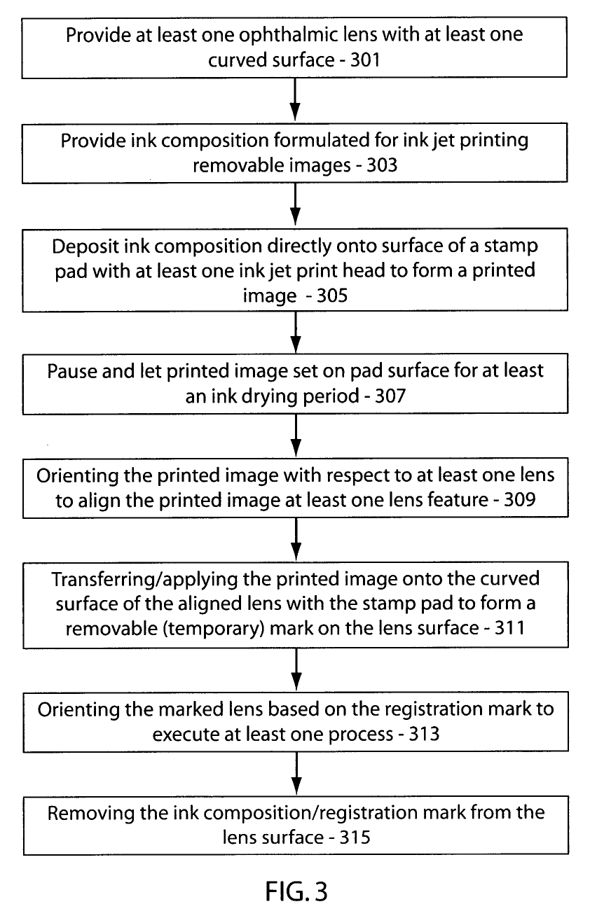

Reference is now made to FIG. 3 which depicts an exemplary method flow for applying an ink composition to an ophthalmic lens to form a temporary mark. This method may be used to place a ‘registration mark’ on a lens blank. Such registration marks may denote the location and/or orientation of optical features and are used during lens processing during, e.g., surfacing and/or edging operations. The type of registration mark applied may vary to indicate different desired orientations, etc. depending on the type of lens being processed. For example, in progressive lens blanks the progressive optical features require proper orientation prior to grinding, e.g., the cylinder into the lens. Polarized lens blanks typically have parallel strands that need to be horizontally oriented when edged for an eyeglass frame. Such polarized lenses may include plano polarized sunglasses (have no power but require edging for a frame), polarized semi-finished lenses (require grinding and edging), polarized single vision lenses (require edging for a frame), etc. Further, lenses may have optical centers in different locations (e.g., ‘off-center’) depending on the lens' geometric configuration. These lenses are designed for certain types of frames.

In step 301, at least one ophthalmic lens is provided having at least one curved or meniscus-shaped surface. Such curved surface may comprise a convex or concave surface, and the lens may comprise any optical lens that may be coated or uncoated e.g., for abrasion resistance, tinting, anti-reflectivity, etc., as described above with reference to FIG. 1.

An ink composition is provided preferably formulated for dispensing via ink jet printing to create a removable image stamped onto a substrate (step 303). The ink composition is deposited/printed directly onto the surface of a stamp pad with at least one ink jet print head to form an imprinted image (step 305). The imprinted image is allowed to set on the pad surface for a period of time (an ‘ink drying period’) which may comprise e.g., at least about 1 second, but preferably no longer than about 10 seconds to 1 minute (step 307). Advantageously, the ink drying period permits the image imprinted on the pad surface to ‘skin over’ sufficiently so as to prevent the undesirable effect of ‘ghosting.’ Ghosting occurs when the image imprinted from the pad to a lens surface bleeds into the lens (e.g., through the lens coating) such that the image is still faintly visible in the lens even after removal of the image.

In step 309, the image imprinted onto the pad is oriented with respect to a lens to which it will be applied to align the imprinted image with at least one lens feature. As discussed above, lens features may comprise, for example, location of progressive lens elements, location of optical center, and orientation of polarizing filters. The pad surface is contacted/pressed onto the curved surface of the aligned lens to transfer the imprinted image from the pad to the lens to form a removable (temporary) mark on the lens surface (step 311).

The lens having the removable mark is processed (step 313), e.g., oriented according to the applied registration mark to perform machining to customize the lens power, sphere, prism or cylinder or edging to fit the lens into a frame. Subsequently, the removable mark on the lens surface (the lens surface being coated or uncoated) may be removed (step 315).

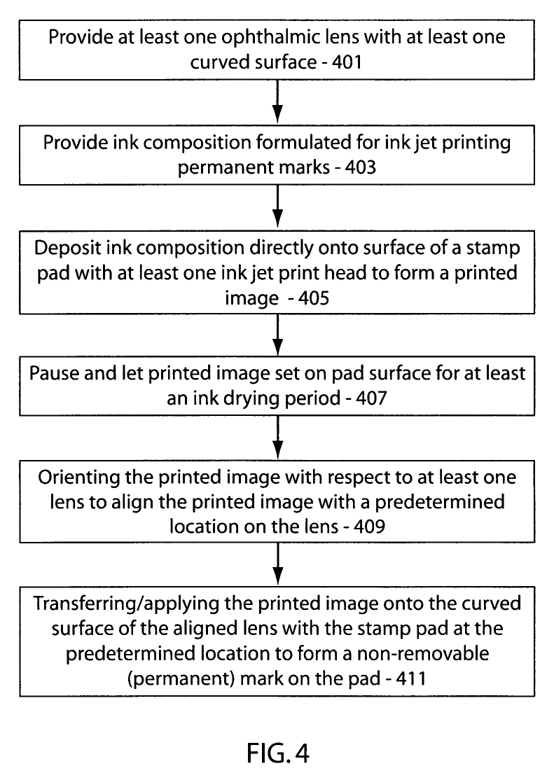

FIG. 4 depicts an exemplary method flow for applying an ink composition to an ophthalmic lens to form a permanent mark. Exemplary permanent marks may comprise, logos, lens model information, etc. which are printed on a curved surface of a finished lens. Preferably, the logo is applied onto a predetermined location on the lens. Such ‘predetermined location’ may comprise any location on the lens which, e.g., is at least non-obstructive to a viewing area of the lens yet outside of a frame periphery of the lens to ensure that the logo is fully visible when the lens is framed. That is, the logo is preferably placed on the periphery of the lens but is not ‘edged out’, nor covered by the frame.

In step 401, at least one ophthalmic lens is provided having at least one curved or meniscus-shaped surface. Such curved surface may comprise a convex or concave surface, and the lens may comprise any optical lens that may be coated or uncoated e.g., for abrasion resistance, tinting, anti-reflectivity, etc., as described above. An ink composition is provided preferably formulated for dispensing via ink jet printing to create a permanent (non-removable) image for stamping onto a substrate (step 403). The ink composition is deposited (printed) directly onto the surface of a stamp pad with at least one ink jet print head to form an imprinted image (step 405). The imprinted image is allowed to set on the pad surface for a period of time (an ‘ink drying period’) which may comprise e.g., at least about 1 second, but preferably no longer than about 10 seconds to 1 minute (step 407).

The ink drying period may be adjusted depending on, e.g., at least an amount of ink composition jetted, a type of ink color blend, and a type of design of the ink composition. A system controller (not shown) may be provided and configured for automatically adjusting/programming the ink drying period. Advantageously, the ink drying period permits the image imprinted on the pad surface to ‘skin over’ sufficiently so as to prevent the undesirable bleeding of the ink into the lens material and/or into any existing underlying coating or in any subsequent overcoats applied thereon.

In step 409, the image imprinted onto the pad is oriented with respect to at least one lens to align the imprinted image with a predetermined location on the lens. As discussed above, such ‘predetermined location’ may comprise any location on the periphery of the lens that is not covered by the frame. The pad surface is contacted/pressed onto the curved surface of the aligned lens to transfer the imprinted image from the pad to the lens to form a permanent mark at the desired predetermined location on the lens surface (step 411).

Having described preferred embodiments for applying an ink composition to an ophthalmic lens, compositions and materials used therein and methods for processing same (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method for applying a temporary registration mark to an ophthalmic lens to identify the location, direction or characteristic of an optical feature comprising the steps of:
providing at least one ophthalmic lens having a meniscus-shaped surface;
providing an ink composition formulated for removable and non-bleeding application onto the surface of the lens, the ink composition having at least a viscosity compatible with ink jet printing;
jetting the ink composition directly onto a stamp via an ink jet print head to form a printed image on said stamp, and pausing for at least an ink drying period; and
applying the printed image onto the lens surface with the stamp to form a registration mark that is indicative of a particular location, direction or characteristic, wherein the ink drying period is of a time duration sufficient to at least prevent bleeding of the ink into the lens upon application onto the lens surface.

2. The method of claim 1, wherein the ophthalmic lens includes an asymmetrical optical feature that requires identification during subsequent machining operations.

3. The method of claim 1, wherein the registration mark comprises a visual indicia of the location or direction of the optical feature.

4. The method of claim 1, wherein prior to said applying step, the method further comprises:
orienting the printed image and the lens with respect to each other to bring the registration mark into alignment with the optical feature.

5. The method of claim 4, wherein said orienting step includes optically analyzing the lens to sense the location or direction of the optical feature.

6. The method of claim 5, wherein said orienting step includes manipulating one of the ink jet print head and the stamp in response to the sensed location or direction.

7. The method of claim 3, wherein the registration mark comprises a visual indicia of the location of a progressive lens feature.

8. The method of claim 3, wherein the registration mark comprises a visual indicia of the location of an asymmetrical optical center.

9. The method of claim 3, wherein the registration mark comprises a visual indicia of the direction of a polarized lens feature.

10. The method of claim 1, wherein after said applying step, the method further comprises the steps of:
aligning the registration mark and a machine tool with respect to each other;
machining the lens; and
removing the temporary registration mark.

11. The method of claim 1, wherein the lens has a meniscus-shaped surface comprises at least one of a convex or a concave surface.

12. The method of claim 1, wherein the lens includes at least one coating layer.

13. The method of claim 12, wherein the coating comprises at least one of an abrasion resistant coating, a tint coating, a scratch resistant coating and an anti-reflective coating.

14. The method of claim 12, wherein the printed image is applied onto the coated lens.

15. The method of claim 1, wherein the stamp is comprised of a flexible, deformable material.

16. The method of claim 1, wherein the registration mark is formulated to be completely removable from the lens surface without ghosting.

17. The method of claim 1, wherein said jetted ink composition comprises a multicolor image.

18. The method of claim 1, wherein the step of jetting further comprises the steps of:
providing the ink jet print head operably connected to a microprocessor for jetting the ink composition, wherein the ink jet print head is controlled by said microprocessor.

19. The method of claim 18, wherein the microprocessor is configured to compensate for jetting onto the stamp at varying distances.

20. The method of claim 18, wherein the microprocessor is configured for:
varying the stamp inflation pressure, in response to a changing base curve; and
changing the print settings to optimize the clarity of the printed image.

21. The method of claim 19, wherein said at least one image comprises a multicolor image that is jetted onto the stamp and applied to the lens in one pass.

22. The method of claim 1, further comprising the step of providing an ink jet printer for jetting the ink onto the stamp.

23. The method of claim 22, wherein the inkjet printer comprises a color ink jet printer configured to jet removable, non-bleeding ink compositions comprised of multiple colors.

24. The method of claim 1, further comprising the step of providing a system controller configured for adjusting the ink drying period.

25. The method of claim 24, wherein the ink drying period is adjusted depending on at least an amount of ink composition jetted, a type of ink color blend, and a type of design of the ink composition.

26. The method of claim 1, further comprising the step of removing the ink composition from the coated lens surface.

27. The method of claim 1, wherein the lens is oriented based on the registration mark to execute at least one process.

28. The method of claim 27, wherein said at least one process comprises at least one of surfacing and edging operations.

29. The method of claim 1, wherein said jetting step comprises moving the ink jet head and the stamp in relation to each other to provide a more consistent non-contact distant therebetween during printing.

30. A method for applying an ink composition to an ophthalmic lens comprising the steps of:
providing at least one ophthalmic lens having a meniscus-shaped surface;
providing an ink composition formulated for non-removable and non-bleeding application onto the surface of the lens, the ink composition having at least a viscosity compatible with ink jet printing;
jetting the ink composition directly onto a stamp via an ink jet print head to form a printed image on said stamp, and pausing for at least an ink drying period;
orienting the printed image with respect to the lens to align the printed image with a specified location on the lens;
applying the printed image onto the lens surface with the stamp to form a permanent mark, wherein the ink drying period is of a time duration sufficient to at least prevent bleeding of the ink into the lens upon application onto the lens surface.

31. The method of claim 30, wherein the meniscus-shaped surface comprises at least one of a convex or a concave surface.

32. The method of claim 30, wherein the lens includes at least one coating layer.

33. The method of claim 32, wherein the coating comprises at least one of an abrasion resistant coating, a tint coating, a scratch resistant coating and an anti-reflective coating.

34. The method of claim 32, wherein the printed image is applied onto the coated lens.

35. The method of claim 30, wherein the stamp is comprised of a flexible, deformable material.

36. The method of claim 30, wherein the permanent mark is formulated to be non-removable from the lens surface.

37. The method of claim 30, wherein said jetted ink composition comprises a multicolor image.

38. The method of claim 30, wherein the step of jetting further comprises the steps of:
providing the ink jet print head operably connected to a microprocessor for jetting the ink composition, wherein the ink jet print head is controlled by said microprocessor.

39. The method of claim 37, wherein the microprocessor is configured for creating at least one image comprising an ink pattern.

30. The method of claim 39, wherein the microprocessor is configured for selecting at least one ink pattern from a plurality of ink patterns.

41. The method of claim 39, wherein said at least one image comprises a multicolor image.

42. The method of claim 40, further comprising the step of providing an ink jet printer for jetting the ink onto the stamp.

43. The method of claim 42, wherein the inkjet printer comprises a color ink jet printer configured to jet temporary, non-bleeding ink compositions comprised of multiple colors.

44. The method of claim 40, further comprising the step of providing a system controller configured for adjusting the ink drying period.

45. The method of claim 44, wherein the ink drying period is adjusted depending on at least an amount of ink composition jetted, a type of ink color blend, and a type of design of the ink composition.

46. The method of claim 30, wherein the specified location on the lens includes a location that is at least non-obstructive to a viewing area of the lens and outside of a frame periphery area of the lens.
